(19) United States
(12) Patent Application Publication
(10) Pub. No.: US 2026/0253318 A1
(43) Pub. Date: Aug. 27, 2026

(54) DYNAMIC CULLING OF GAUSSIAN SPLATS USING LEVEL OF PRECISION

(71) Applicant: HUAWEI TECHNOLOGIES CO., LTD., Shenzhen (CN)

(72) Inventors: Shuja KHALID, Scarborough (CA); Keyi LIU, Markham (CA); Shufang LU, Markham (CA); Yehor POLSCHCHA, Toronto (CA); Mohamed Ibrahim Hafez IBRAHIM, Milton (CA); Yang LIU, Toronto (CA)

(21) Appl. No.: 19/061,180

(22) Filed: Feb. 24, 2025

(51) Int. Cl. G06T 15/40

(52) U.S. Cl. CPC G06T 15/40

(57) ABSTRACT

The methods, devices, and systems to support the adaptive real-time post-processing culling technique to balance between rendering quality and performance are disclosed. In one embodiment the device uses hard thresholds for opacity and granularity assessment in its dynamic culling component to execute the performance mode when all Gaussians attributes with values that are less than the hard thresholds are culled. In another embodiment, the device uses both hard and soft thresholds for opacity and granularity in the dynamic culling component to execute the balanced mode uses hard

$$( {τ}_{h}^{o p a c i t y} , {τ}_{h}^{g r a n ularity} )$$

and soft

$$( {τ}_{s}^{opacity} , {τ}_{s}^{g r a n ularity} )$$

thresholds. All Gaussian ellipsoids that are less than the hard thresholds are culled immediately. All remaining Gaussians below the soft threshold are quantized in the quantization component and rendered in the rendering component. The resulting image may have better quality than just culling.

### TECHNICAL FIELD

The present technology generally pertains to methods, devices, and systems for 3D reconstruction of a scene, and, in particular, to methods, devices, and systems to support dynamic culling of gaussian splats in 3D image rendering applications.

### BACKGROUND

Novel view synthesis is a technique in computer vision and graphics that generates new images of a scene from viewpoints that were not part of the original dataset. This involves creation of realistic images from different angles, lighting conditions, or perspectives based on a limited set of input images. The goal is to produce visually coherent and accurate representations of the scene as if they were captured from those new viewpoints. The novel view synthesis proves to be a useful technique in many applications, such as 3D/4D scene reconstruction from a set of input images enabling operations like scene navigation; creation of global illumination effects such as ambient occlusion, indirect light and shadows (Baked in global illumination.). The novel view synthesis may be used to support spatial Intelligence to enable ‘agents’ to ‘observe’ the 3D world, ‘understand’ it and ‘act’ upon its understanding to perform various tasks; to captured from the input images high quality materials at better resolution than rendered materials. The novel view synthesis may be used to extract 3D meshes (inverse rendering), the bidirectional reflectance distribution function (BRDF), ambient occlusion and depth maps.

Three-Dimensional Gaussian Splatting (3DGS) is a method which may be used in the context of 3D reconstruction and novel view synthesis. It involves representing a 3D scene using a set of Gaussian ellipsoids, which are mathematical shapes that may efficiently model the scene's geometry and appearance. FIG. 1 illustrates the attributes required to mathematically represent a 3D Gaussian ellipsoid in space. In this disclosure, Gaussian ellipsoids will be often referred to as “Gaussians”. There may be, for example, 59 attributes, each require four-byte floating point values to represent. Spherical harmonics (SPH) attributes capture view dependent colour effects of 3D Gaussian ellipsoids in space. There may be also XYZ attributes, scale attributes, and rotation attributes. Therefore, a scene, containing 6 million Gaussians, would require 59× 4×6,000,000=~ 1.5 GB. 3DGS method contrasts with neural implicit representations like Neural Radiance Fields (NeRFs) (B. J. Mildenhall, Neural Scene Representations for View Synthesis, UC Berkeley dissertation, fall 2020), which uses neural networks to encode the scene.

3DGS (B. Kerbl et al., “3D Gaussian Splatting for Real-Time Radiance Field Rendering”, ACM Trans. Graph., pp. 1-25, 2023) methods represent the 3D world with a set of 3D points, hundreds of thousands or millions. Each point is a 3D Gaussian ellipsoid with its own unique parameters that are fitted per scene such that renders of this scene match closely to the known dataset images. Each 3D Gaussian ellipsoid is parameterized by: a mean μ interpretable as location x, y, z; a covariance matrix Σ; an opacity value σ(α) (a sigmoid function is applied to map the parameter to the [0, 1] interval), and color parameters, either 3 values for (R, G, B) or spherical harmonics (SH) coefficients.

Compared to NeRFs, 3D Gaussian methods have the following advantages. There is no multi-layer perception (MLP) to be inferenced HWP times for a single image, as 2D Gaussians are blended onto an image directly. Additionally, there is no ambiguity in which 3D point to evaluate along the ray, no need to choose a ray sampling strategy (a set of 3D points overlapping the ray of each pixel (N) is discrete and fixed after optimization). Finally, a pre-processing sorting stage is done once per frame, on a graphics processing unite (GPU), using a custom implementation of differentiable Compute Unified Device Architecture (CUDA) kernels. Instant neural graphics primitives (NGP) of NeRF, Mip-NeRF, and 3DGS methods may be compared in terms of image quality (the peak-signal-to-noise ration (PSNR), the structural similarity index measure (SSIM)), rendering (frame-per-second (FPS)) and training performance.

In a process called densification some Gaussian ellipsoids may be added to the existing point cloud in order to add more complexity to the scene and capture finer details. The densification process may be accompanied by a pruning or culling stage in which Gaussians are subsequently removed from the scene once it's determined that they do not contribute to the scene in a meaningful way. Both stages (densification and pruning) may be done during the training process.

Quantization is a technique in computer science where data is converted into a compressed representation. In Gaussian splatting, large amounts of data (such as 3D coordinates, color values, and densities) may need to be processed. Quantization may reduce the number of bits required to represent each data point. For example, instead of storing high-precision floating-point numbers for each Gaussian ellipsoid's position and color, quantization may reduce the precision to a smaller range (such as 8-bit or 16-bit). This reduces memory usage and computational overhead, may allow for faster processing, storage, and transmission of the data. Some other benefits associated with quantization, specifically in the field of graphics and computer vision, include the ability to handle large point clouds that would have otherwise not been possible due to memory constraints, and optimization for real-time applications by reducing memory usage and bandwidth.

A pruning threshold may be used (P. Papantonakis, “Reducing the Memory Footprint of 3D Gaussian Splatting”, Proceedings of the ACM on Computer Graphics and Interactive Techniques, pp. 1-17, 2024) for Gaussian pruning and redundancy awareness during training and/or fine-tuning to cull away and subsequently modify Gaussian ellipsoids. This may lead to a significant reduction in memory footprint. Subsequently, spherical harmonics assignment may be used to assign different Spherical harmonics levels (SPH). Since spherical harmonics are of a very high dimension, during training, the appropriate spherical harmonics may be assigned to significantly reduce its dimensionality. The training stage may be followed by a gaussian vector quantization. A vector codebook may be created which contains a mapping from selected Gaussian parameter to a fixed set of vectors. The codebook may require clustering which is a computationally expensive process. A multi-step process that may be used during training the Gaussian parameters of the model.

Gaussian pruning and recovery during training and/or fine-tuning culls may be followed by the modification stage to compensate for the original cull. A multi-step process may be employed to decrease the total number of Gaussian ellipsoids in the scene during the training process. This may lead to a significant reduction in memory footprint. The method also uses spherical harmonics (SH) distillation. Since spherical harmonics are of a very high dimension, during training, the spherical harmonics may be reduced, at the expense of quality. Finally, Gaussian vector quantization, a vector codebook may be created to map each Gaussian parameter to a fixed set of vectors. The codebook may require clustering to cluster the Spherical harmonics into groups and/or bins from which sampling may be done during run-time.

Image rendering applications involving compression may improve point-cloud performance and complexity at the cost of image quality. Since this process is done during training, it may be expensive and isn't guaranteed to converge to an optimal solution. Training and/or fine-tuning is required to achieve memory/performance improvements. However, these operations may be time consuming and conditioned to GPU availability, not ideal for real-time and mobile applications as dependent on dataset attributes, challenging scenes with a high number of Gaussian parameters may require more time to train and/or fine-tune. Training and fine-tuning optimization strategies are non-deterministic, and the effect of each optimization technique may vary based on the dataset. A zero-shot compression approach may be required, for example, as a post-processing step for significantly pruning Gaussians to improve performance and to maintain a high-quality image. Therefore, improvements in 3D reconstruction of a scene are desirable.

### SUMMARY

The present disclosure relates to methods, devices, and systems to support dynamic culling of gaussian splats. Disclosed the method for an adaptive real-time post-processing culling technique to balance between rendering quality and performance. The disclosed method may be applicable to compress and cull in post-processing pipelines, that follows a traditional and/or custom 3DGS training process. The method is agnostic to the scene and the training stage. The method may be applied on-the-fly during rendering, no re-training and/or fine-tuning is required. An adaptive real-time post-processing level of precision technique for assigning a lower precision to Gaussian attributes (for example, reducing the number of Gaussian ellipsoids and quantizing them to a lower representation) may be used to decrease memory bandwidth requirements and cache misses, which may improve rendering performance. The method may offer control during rendering as the performance of the model may be either preset or adjusted on-the-fly during rendering. Quality adjustment may be done based on available resources which makes the disclosed method suitable for mobile rendering and/or real-time rendering.

According to embodiments of the present disclosure, there is provided a method for dynamic culling of gaussians to render a scene. The method comprising, by a device: receiving a first plurality of gaussians representing the scene, each gaussian of the first plurality being associated with a respective first parameter and a respective second parameter; receiving a first threshold value and a second threshold value; receiving a request to render the scene; initiating a discovery operation to discover at least one gaussian of the first plurality, a value of a first parameter of the at least one gaussian is less than the first threshold value and a value of a second parameter of the at least one gaussian is less than the second threshold value; in response to determining that the discovery operation to discover the at least one gaussian was successful, culling the at least one gaussian; generating a second plurality of gaussians, the second plurality of gaussians being based at least in part on the first plurality of gaussians, each gaussian of the second plurality of gaussians being associated with a respective first parameter and a respective second parameter, and a value of the respective first parameter is equal to or greater than the first threshold value, or a value of the respective second parameter is equal to or greater than the second threshold value, or both; and generating a rendered image of the scene using the second plurality of gaussians. According to some embodiments, the each gaussian of the second plurality of gaussians associated with a respective plurality of attributes; the respective first parameter being based at least in part on one or more attributes of the respective plurality of attributes; and the respective second parameter being based at least in part on at least one attribute of the respective plurality of attributes. In some embodiments, the respective plurality of attributes includes a corresponding opacity attribute; and the respective first parameter is a respective opacity parameter, and the value of the respective first parameter is a value of the corresponding opacity attribute. In some embodiments, the respective plurality of attributes includes corresponding one or more rotation attributes, corresponding one or more scale attributes, or a combination thereof; and the respective second parameter is a respective granularity parameter, and the value of the respective second parameter is based at least in part on values of the corresponding one or more scale attributes, on values of the corresponding one or more rotation attributes, or a combination of thereof. In some other embodiments, the respective second parameter is a respective granularity parameter, and the value of the respective second parameter is based at least in part on a distance from the each gaussian of the second plurality to a camera viewpoint.

According to some other embodiments of the present disclosure, there is provided a method for dynamic culling of gaussians to render a scene. The method comprising, by a device: receiving a first plurality of gaussians representing the scene, each gaussian of the first plurality being associated with a respective first parameter and a respective second parameter; receiving a first threshold value and a second threshold value; receiving a third threshold value and a fourth threshold value; receiving a request to render the scene; initiating a discovery operation to discover at least one gaussian of the first plurality, a value of a first parameter of the at least one gaussian is less than the first threshold value and a value of a second parameter of the at least one gaussian is less than the second threshold value; in response to determining that the discovery operation to discover the at least one gaussian was successful, culling the at least one gaussian; generating a second plurality of gaussians, the second plurality of gaussians being based at least in part on the first plurality of gaussians, each gaussian of the second plurality of gaussians being associated with a respective first parameter and a respective second parameter, and a value of the respective first parameter is equal to or greater than the first threshold value, or a value of the respective second parameter is equal to or greater than the second threshold value, or both; generating a third plurality of gaussians, the third plurality of gaussians being based at least in part on the second plurality of gaussians, each gaussian of the third plurality of gaussians being associated with a respective first parameter and a respective second parameter, and a value of the respective first parameter is equal to or greater than the third threshold value, or a value of the respective second parameter is equal to or greater than the fourth threshold value, or both; generating a fourth plurality of gaussians, the fourth plurality of gaussians being based at least in part on the second plurality of gaussians, each gaussian of the fourth plurality of gaussians being associated with a respective first parameter and a respective second parameter, a value of the respective first parameter is less than the third threshold value and a value of the respective second parameter is less than the fourth threshold value; and generating a rendered image of the scene using the third and the fourth plurality of gaussians.

In some embodiments, the each gaussian of the second plurality of gaussians, the each gaussian of the third plurality, the each gaussian of the fourth plurality is associated with a respective plurality of attributes; and wherein each attribute has a respective scalar quantization. In some embodiments, prior to said generating the rendered image of the scene, selecting one or more attributes from the respective plurality of attributes of the each gaussian of the fourth plurality; and adjusting a corresponding scalar quantization of the one or more attributes from the respective plurality of attributes of the each gaussian of the fourth plurality. In some other embodiments, said adjusting the corresponding scalar quantization is replacing a 32-bit representation with a reduced value representation, and in some embodiments, the one or more attributes are spherical harmonic attributes. In some embodiments, the respective first parameter of the each gaussian of the second plurality being based at least in part on one or more attributes of the respective plurality of attributes; the respective first parameter of the each gaussian of the third plurality being based at least in part on one or more attributes of the respective plurality of attributes; the respective first parameter of the each gaussian of the fourth plurality being based at least in part on one or more attributes of the respective plurality of attributes; and the respective second parameter of the each gaussian of the second plurality being based at least in part on at least one attribute of the respective plurality of attributes; the respective second parameter of the each gaussian of the third plurality being based at least in part on at least one attribute of the respective plurality of attributes; and the respective second parameter of the each gaussian of the fourth plurality being based at least in part on at least one attribute of the respective plurality of attributes.

In some embodiments of the present disclosure, the respective plurality of attributes of the each gaussian of the second plurality, the respective plurality of attributes of the each gaussian of the third plurality, and the respective plurality of attributes of the each gaussian of the fourth plurality includes a corresponding opacity attribute; the respective first parameter of the each gaussian of the second plurality is a respective opacity parameter of the each gaussian of the second plurality, and the value of the respective first parameter of the each gaussian of the second plurality is a value of the corresponding opacity attribute; the respective first parameter of the each gaussian of the third plurality is a respective opacity parameter of the each gaussian of the third plurality, and the value of the respective first parameter of the each gaussian of the third plurality is a value of the corresponding opacity attribute; and the respective first parameter of the each gaussian of the fourth plurality is a respective opacity parameter of the each gaussian of the fourth plurality, and the value of the respective first parameter of the each gaussian of the fourth plurality is a value of the corresponding opacity attribute.

In some embodiments, the respective plurality of attributes of the each gaussian of the second plurality includes corresponding one or more rotation attributes, corresponding one or more scale attributes, or a combination thereof; and the respective second parameter of the each gaussian of the second plurality is a respective granularity parameter, and the value of the respective second parameter of the each gaussian of the second plurality is based at least in part on values of the corresponding one or more scale attributes, on values of the corresponding one or more rotation attributes, or a combination of thereof. In some other embodiments, the respective second parameter of the each gaussian of the second plurality is a respective granularity parameter, and the value of the respective second parameter is based at least in part on a distance from the each gaussian of the second plurality to a camera viewpoint.

In some embodiments, the respective plurality of attributes of the each gaussian of the third plurality includes corresponding one or more rotation attributes, corresponding one or more scale attributes, or a combination thereof; and the respective second parameter of the each gaussian of the third plurality is a respective granularity parameter, and the value of the respective second parameter of the each gaussian of the third plurality is based at least in part on values of the corresponding one or more scale attributes, on values of the corresponding one or more rotation attributes, or a combination of thereof. In some other embodiments, the respective second parameter of the each gaussian of the third plurality is a respective granularity parameter, and the value of the respective second parameter is based at least in part on a distance from the each gaussian of the third plurality to a camera viewpoint.

In some embodiments, the respective plurality of attributes of the each gaussian of the fourth plurality includes corresponding one or more rotation attributes, corresponding one or more scale attributes, or a combination thereof; and the respective second parameter of the each gaussian of the fourth plurality is a respective granularity parameter, and the value of the respective second parameter of the each gaussian of the fourth plurality is based at least in part on values of the corresponding one or more scale attributes, on values of the corresponding one or more rotation attributes, or a combination of thereof. In some other embodiments, the respective second parameter of the each gaussian of the fourth plurality is a respective granularity parameter, and the value of the respective second parameter is based at least in part on a distance from the each gaussian of the fourth plurality to a camera viewpoint.

In accordance with some embodiments, there is provided a device to support dynamic culling of gaussians to render a scene. The device includes one or more processors executing instructions stored on a memory. The device is configured to: receive a first plurality of gaussians representing the scene, each gaussian of the first plurality being associated with a respective first parameter and a respective second parameter; receive a first threshold value and a second threshold value; receive a request to render the scene; initiate a discovery operation to discover at least one gaussian of the first plurality, a value of a first parameter of the at least one gaussian is less than the first threshold value and a value of a second parameter of the at least one gaussian is less than the second threshold value; in response to determining that the discovery operation to discover the at least one gaussian was successful, cull the at least one gaussian; generate a second plurality of gaussians, the second plurality of gaussians being based at least in part on the first plurality of gaussians, each gaussian of the second plurality of gaussians being associated with a respective first parameter and a respective second parameter, and a value of the respective first parameter is equal to or greater than the first threshold value, or a value of the respective second parameter is equal to or greater than the second threshold value, or both; and generate a first rendered image of the scene using the second plurality of gaussians.

In some embodiments, the device is further configured to: prior said receipt of the request to render the scene, receive a third threshold value and a fourth threshold value; following said generation of the second plurality of gaussians, generate a third plurality of gaussians, the third plurality of gaussians being based at least in part on the second plurality of gaussians, each gaussian of the third plurality of gaussians being associated with a respective first parameter and a respective second parameter, and a value of the respective first parameter is equal to or greater than the third threshold value, or a value of the respective second parameter is equal to or greater than the fourth threshold value, or both; generate a fourth plurality of gaussians, the fourth plurality of gaussians being based at least in part on the second plurality of gaussians, each gaussian of the fourth plurality of gaussians being associated with a respective first parameter and a respective second parameter, a value of the respective first parameter is less than the third threshold value and a value of the respective second parameter is less than the fourth threshold value; and generate a second rendered image of the scene using the third and the fourth plurality of gaussians.

In accordance with embodiments, there is provided an electronic device in a communication network, the device including a processor, a network interface and a memory and configured to perform one or more of the methods as described herein. In accordance with embodiments, there is provided a system of such electronic device, networked together and configured to interact to perform one or more of the methods as described herein.

In accordance with an embodiment of the present disclosure, there is provided a computer program product including a (e.g. non-transitory) computer readable medium having statements and instructions stored thereon which, when executed by one or more computer processors, cause the computer processors to perform the method as set forth above. The computer processors may be parts of one or more electronic devices (e.g. network entities) as described herein.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present invention will become apparent from the following detailed description, taken in combination with the appended drawings, in which:

FIG. 1 illustrates the attributes required to mathematically represent 3D Gaussian ellipsoids in space.

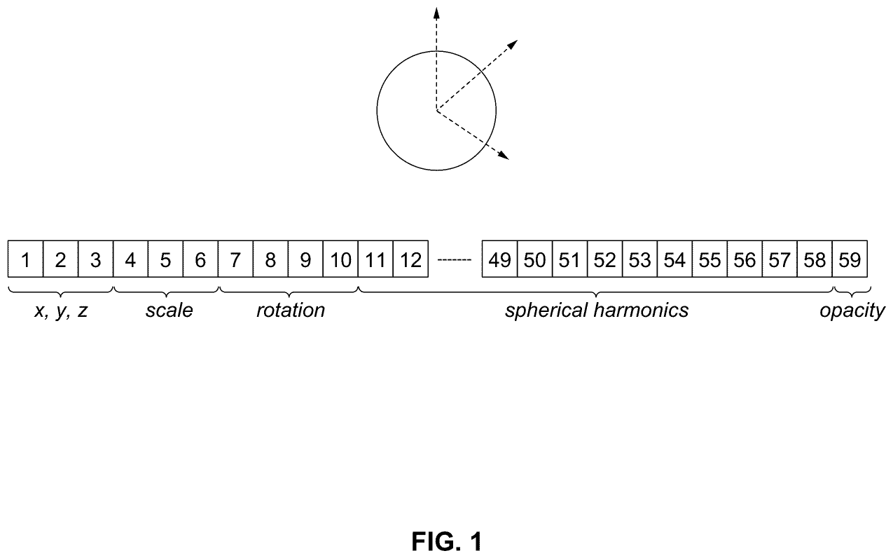

FIG. 2 illustrates the granularity criteria for calculating the importance of each Gaussian ellipsoid.

FIG. 3 illustrates an example of the device for dynamic culling of gaussians in accordance with certain non-limiting embodiments of the present technology.

FIG. 4 illustrates another example of the device for dynamic culling of gaussians in accordance with certain non-limiting embodiments of the present technology.

FIG. 5 illustrates the flowchart of the method for dynamic culling of gaussians to render a scene according to some non-limiting embodiments.

FIG. 6 illustrates another example of the device for dynamic culling of gaussians in accordance with certain non-limiting embodiments of the present technology.

FIG. 7 illustrates the flowchart of the method for dynamic culling of gaussians according to some other non-limiting embodiments.

FIG. 8 illustrates the disclosed embodiments (Dynamic culling; Dynamic Culling+LoP) using various performance and image quality metrics on the Bicycle scene extracted from the MipNeRF360.

FIG. 9 illustrates the disclosed embodiments using various performance and image quality metrics on a Building scene.

FIG. 10 illustrates the disclosed embodiments using various performance and image quality metrics on a scene extracted from the KITTI dataset.

FIG. 11 illustrates an electronic device which may be configured to perform operations according to embodiments of the present disclosure.

It will be noted that throughout the appended drawings, like features are identified by like reference numerals.

### DETAILED DESCRIPTION

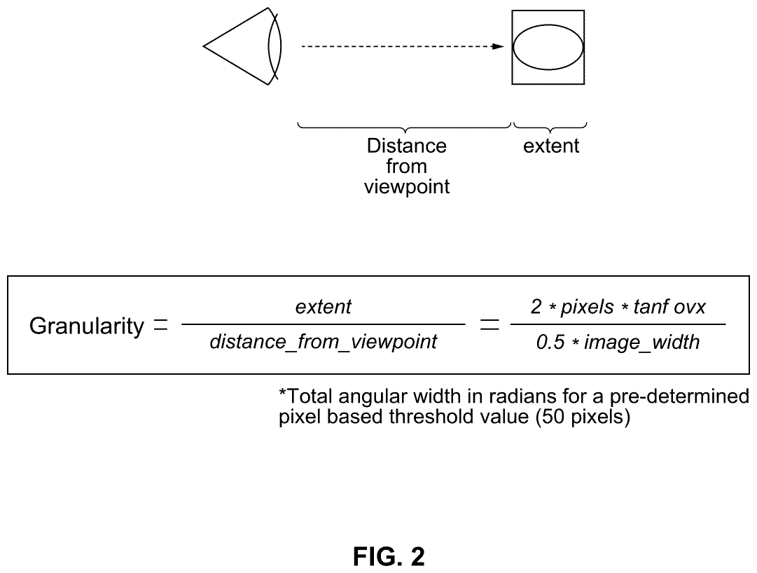

The quality of the image is bound by the quality of the input image. The disclosed method may not create new Gaussian ellipsoids, it culls and/or prunes Gaussians according their importance in the scene. FIG. 2 illustrates the granularity criteria for calculating the importance of each Gaussian ellipsoid and its contribution to the overall scene. The granularity criteria may be defined by the extent and the distance from viewpoint parameters. Gaussians may be ordered according to their importance and culled as needed. The reduction in Gaussian ellipsoids representing the scene may lead to its improvement. The following two criteria may be used to determine the importance of each Gaussian to the scene:

Granularity threshold

$$( {τ}_{0}^{g r a n u l a r i t y} ) ,$$

which is the ratio of the physical extent of the 3D axis-aligned bounding box that encapsulates the Gaussian and the distance from the camera viewpoint. A threshold for granularity may be a “hard” threshold

$${τ}_{h}^{g r a n ularity}$$

below which all Gaussians are immediately culled. A threshold for granularity may be a “soft” threshold

$${τ}_{s}^{g r a n ularity}$$

below which all Gaussians are assigned a lower precision.

Opacity threshold

$$( {τ}_{0}^{opacity} ) ,$$

which is the calculated opacity assigned to the Gaussian. Near transparent Gaussian ellipsoids (within an empirical threshold) may be culled. A threshold for opacity maybe a “hard” threshold

$${τ}_{h}^{o p a c i t y}$$

below which all Gaussians are immediately culled. A threshold for opacity may be a “soft” threshold

$${τ}_{s}^{opacity}$$

below which all Gaussians are assigned a lower precision.

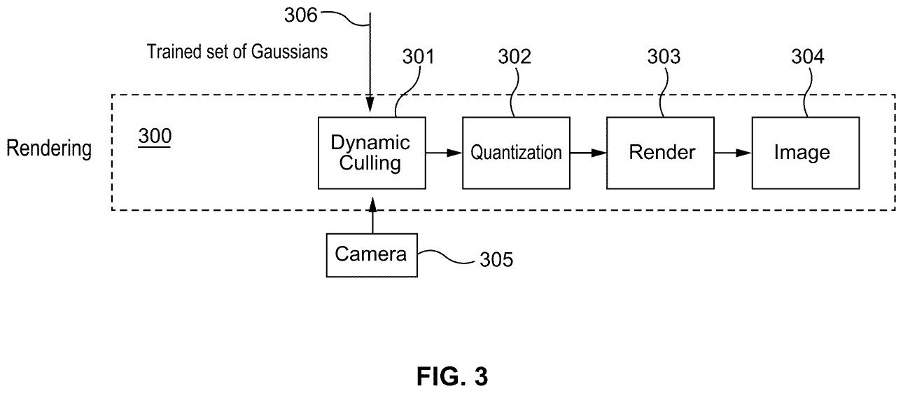

FIG. 3 illustrates an example of device 300 in accordance with certain non-limiting embodiments of the present technology. Device 300 receives trained set of Gaussians 306 and camera viewpoint indication 305. Device 300 may cull Gaussians 306 according to the aforementioned thresholds. Device 300 may include dynamic culling component 301, quantization component 302, rendering component 303, and imaging component 304. In this disclosure, the term “culling” is being defined as an equivalent to pruning, or removing, or discarding.

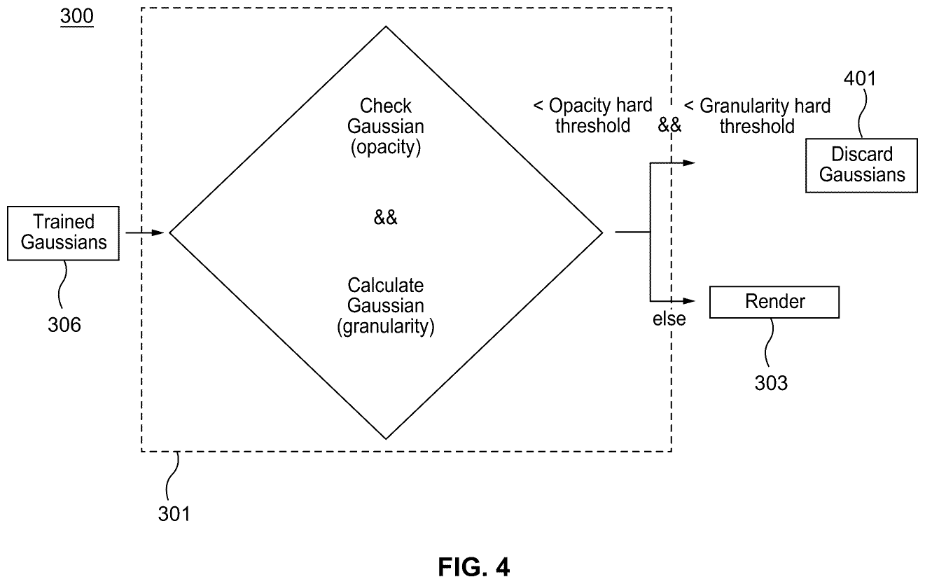

FIG. 4 illustrates an example of device 300 for dynamic culling of gaussians according to some non-limiting embodiments. Device 300 receives a sample dataset of 1,000,000 Gaussian ellipsoids (306) and uses hard thresholds for opacity and granularity assessment in dynamic culling component 301. Performance mode uses hard thresholds

$$( {τ}_{h}^{opacity} , {τ}_{h}^{g r a n ularity} ) :$$

all Gaussians attributes with values that are less than the hard thresholds are culled (401), and the resulting image has much better quality than just culling (performance mode).

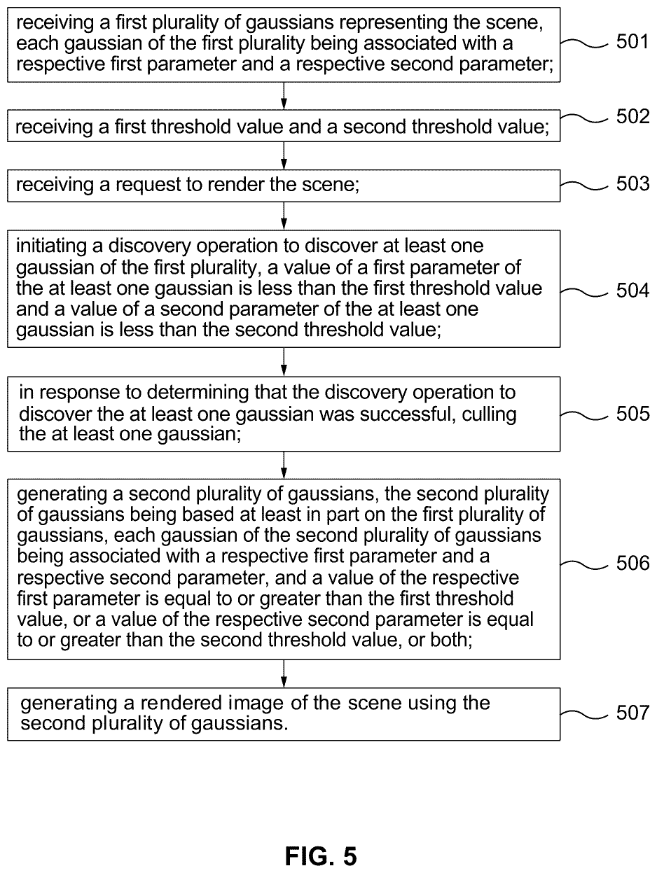

FIG. 5 illustrates the flowchart of the method for dynamic culling of gaussians according to some non-limiting embodiments. At action 501, receiving a first plurality of gaussians representing the scene, each gaussian of the first plurality being associated with a respective first parameter and a respective second parameter. At action 502, receiving a first threshold value and a second threshold value. At action 503, receiving a request to render the scene. At action 504, initiating a discovery operation to discover at least one gaussian of the first plurality, a value of a first parameter of the at least one gaussian is less than the first threshold value and a value of a second parameter of the at least one gaussian is less than the second threshold value. At action 505, in response to determining that the discovery operation to discover the at least one gaussian was successful, culling the at least one gaussian. At action 506, generating a second plurality of gaussians, the second plurality of gaussians being based at least in part on the first plurality of gaussians, each gaussian of the second plurality of gaussians being associated with a respective first parameter and a respective second parameter, and a value of the respective first parameter is equal to or greater than the first threshold value, or a value of the respective second parameter is equal to or greater than the second threshold value, or both. And at action 507, generating a rendered image of the scene using the second plurality of gaussians.

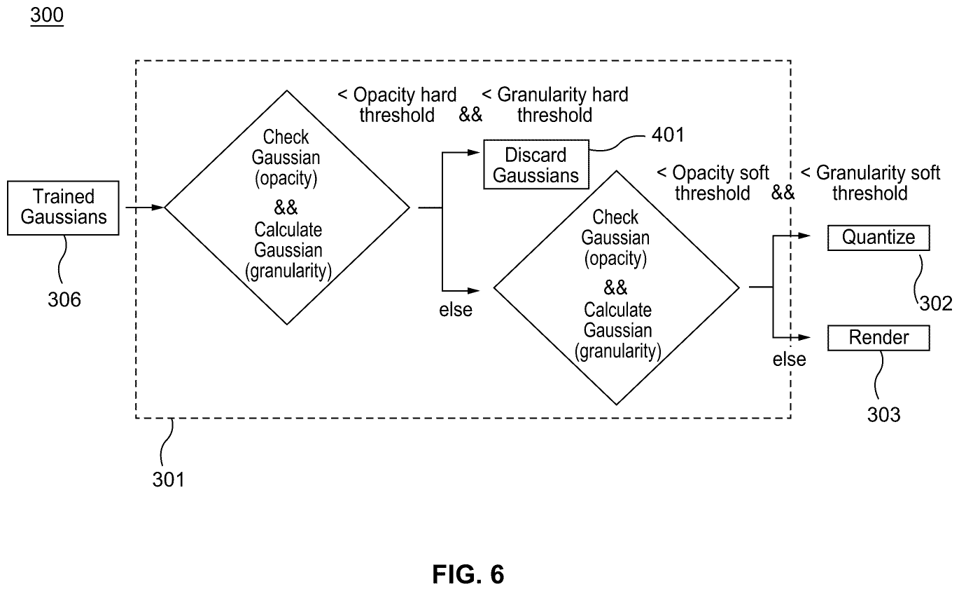

FIG. 6 illustrates a non-limiting embodiment of device 300. Device 300 receives dataset of 1,000,000 Gaussian ellipsoids (306) and uses both hard and soft thresholds for opacity and granularity in dynamic culling component 301: Balanced mode uses hard

$$( {τ}_{h}^{opacity} , {τ}_{h}^{g r a n ularity} )$$

and soft

$$( {τ}_{s}^{o p a c i t y} , {τ}_{s}^{g r a nularity} )$$

thresholds. All Gaussian ellipsoids that
are less than the hard thresholds are culled immediately (401). All remaining Gaussians below the soft threshold are quantized in quantization component 302 and rendered in rendering component 303. The resulting image may have better quality than just culling.

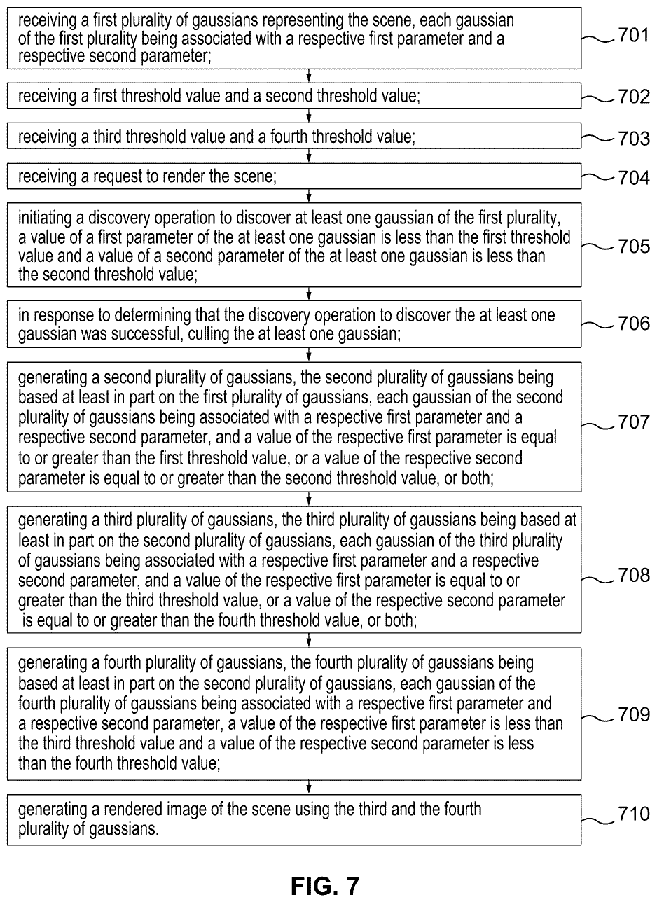

FIG. 7 illustrates the flowchart of the method for dynamic culling of gaussians according to some other non-limiting embodiments. At action 701, receiving a first plurality of gaussians representing the scene, each gaussian of the first plurality being associated with a respective first parameter and a respective second parameter. At action 702, receiving a first threshold value and a second threshold value. At action 703, receiving a third threshold value and a fourth threshold value. At action 704, receiving a request to render the scene. At action 705, initiating a discovery operation to discover at least one gaussian of the first plurality, a value of a first parameter of the at least one gaussian is less than the first threshold value and a value of a second parameter of the at least one gaussian is less than the second threshold value. At action 706, in response to determining that the discovery operation to discover the at least one gaussian was successful, culling the at least one gaussian. At action 707, generating a second plurality of gaussians, the second plurality of gaussians being based at least in part on the first plurality of gaussians, each gaussian of the second plurality of gaussians being associated with a respective first parameter and a respective second parameter, and a value of the respective first parameter is equal to or greater than the first threshold value, or a value of the respective second parameter is equal to or greater than the second threshold value, or both. At action 708, generating a third plurality of gaussians, the third plurality of gaussians being based at least in part on the second plurality of gaussians, each gaussian of the third plurality of gaussians being associated with a respective first parameter and a respective second parameter, and a value of the respective first parameter is equal to or greater than the third threshold value, or a value of the respective second parameter is equal to or greater than the fourth threshold value, or both. At action 709, generating a fourth plurality of gaussians, the fourth plurality of gaussians being based at least in part on the second plurality of gaussians, each gaussian of the fourth plurality of gaussians being associated with a respective first parameter and a respective second parameter, a value of the respective first parameter is less than the third threshold value and a value of the respective second parameter is less than the fourth threshold value. And, at action 710, generating a rendered image of the scene using the third and the fourth plurality of gaussians.

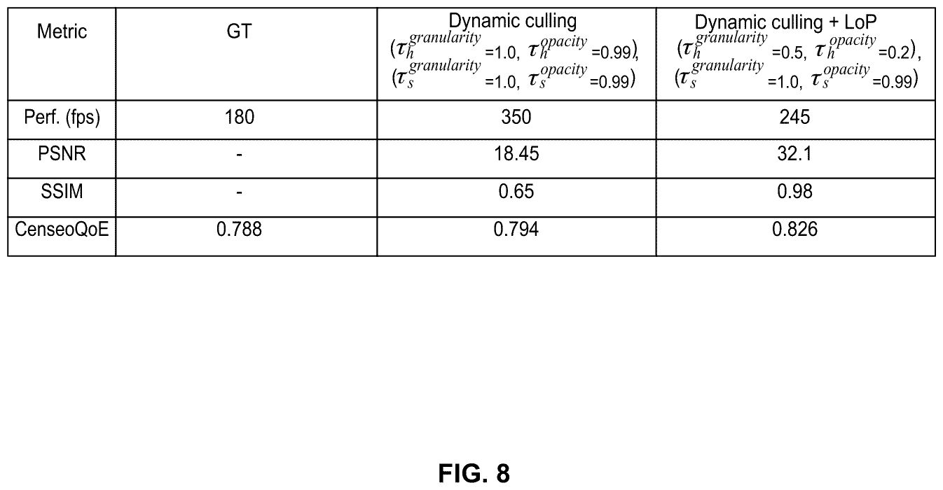

FIG. 8 illustrates application of the disclosed embodiments (Dynamic culling; Dynamic Culling+level of precision (LoP)) using various performance and image quality metrics (PSNR, FPS, SSIM, and CenseoQoE) on the Bicycle scene extracted from the MipNeRF360 dataset (J. T. Barron, et al. “Mip-nerf 360: Unbounded anti-aliased neural radiance fields.” Proceedings of the IEEE/CVF conference on computer vision and pattern recognition, pp. 5470-5479, 2022). The disclosed embodiments are compared to the ground truth (GT) standard. Level of precision allows for various Gaussians in a dense point cloud to be represented using a smaller, and more compact computational representation. For example, point clouds consist of 59 attributes per Gaussian that are trained. Each attribute is represented using a floating-point 32-bit representation. However, each attribute may be represented with less bits such as 16-bit, 8-bit, or 6-bit representation. Qualitative and quantitative results presented on a variety of datasets show that the disclosed invention's adaptability to various applications and domains. The previously defined thresholds

$${τ}_{h}^{o p a c i t y} , {τ}_{s}^{opacity} , {P}_{h}^{granularity} , {τ}_{s}^{granularity}$$

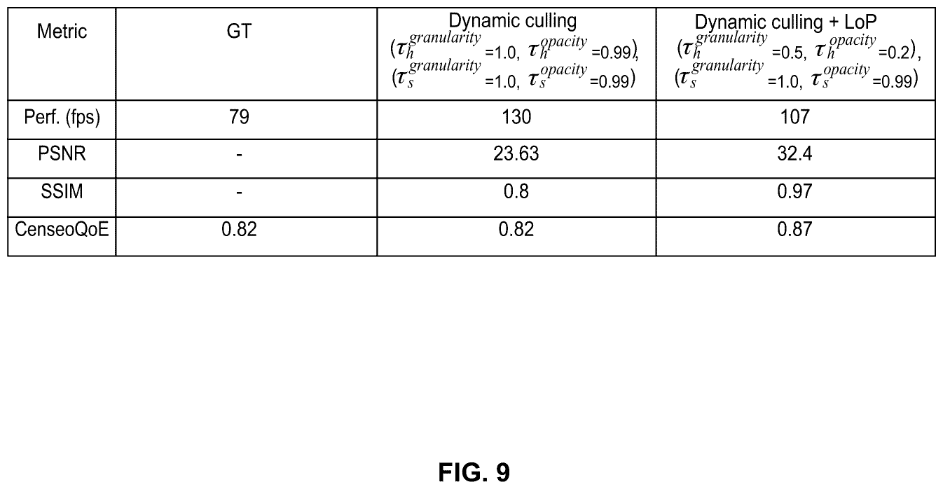

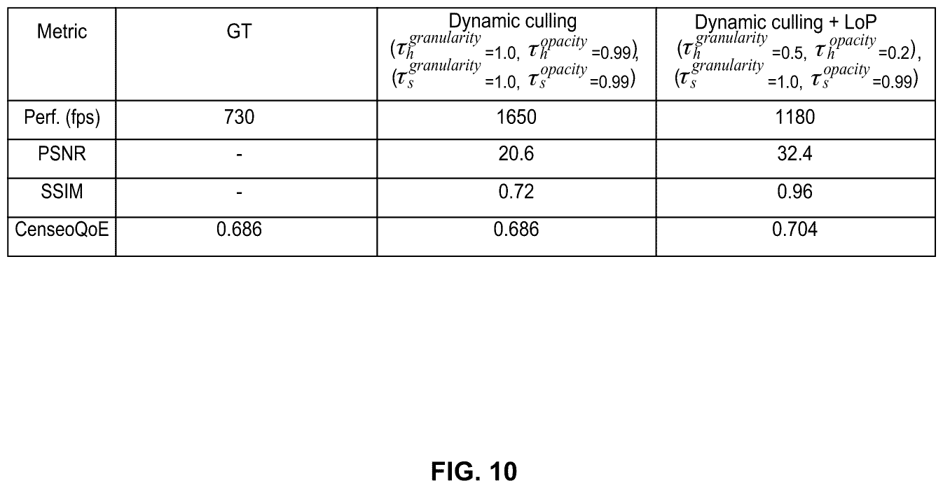

may provide a balance between performance and perceptual image quality. The user may change these parameters in real-time to improve on either attribute depending on their task. The thresholds may also serve as pre-defined application specific values determined by the application's maintainer, similar to how most machine learning models are deployed once there is consensus on the precision/recall trade-off, which are task dependent. FIG. 9 illustrates the disclosed embodiments using various performance and image quality metrics on a Building scene. FIG. 10 illustrates the disclosed embodiments using various performance and image quality metrics on a scene extracted from the KITTI dataset (A. Geiger et al, “Are we ready for autonomous driving? The KITTI vision benchmark suite”, IEEE conference on computer vision and pattern recognition, pp. 3354-3361, 2012).

The disclose method may be applicable in a variety of settings due to its modularity and flexibility. The method may be applicable to any dataset and any trained set of Gaussian ellipsoids, generated by any technique, provided the pre-requisites (Gaussian attributes such as opacity and position) are present. The method may allow a renderer to adaptively adjust to various hardware/software constraints. Since training is expensive different applications may want to run the same model on different hardware that has different constraints. The disclosed method may provide to account for these different constraints without re-training. The method may also be applicable in real-time and therefore may be added to existing Gaussian splatting viewers and/or renderers as a feature to adapt to an available memory bandwidth and for providing a balance between performance and image quality. The disclosed method may support virtual reality-based systems where the environment is rendered using Gaussian splats. Such a virtual reality system would have to effectively adapt to available hardware constraints and available memory bandwidth. The disclosed method may support simulation systems for generating synthetic data for training AI models for autonomous driving vehicles, or any embodied agents (fore example, AI robots, autonomous vehicles, other perception based systems). The disclosed method may support an interactive web-based renderer that takes trained point clouds as input and renders a 3D scene using Gaussian Splats. Such a web-based renderer would have hardware and network bandwidth constraints and would thus have to adapt their rendering in a dynamic way. The disclosed method may support mobile applications and/or games with interactive environments generated using Gaussian splats, where adaptive frame-rates are defined by the device and network bandwidth constraints.

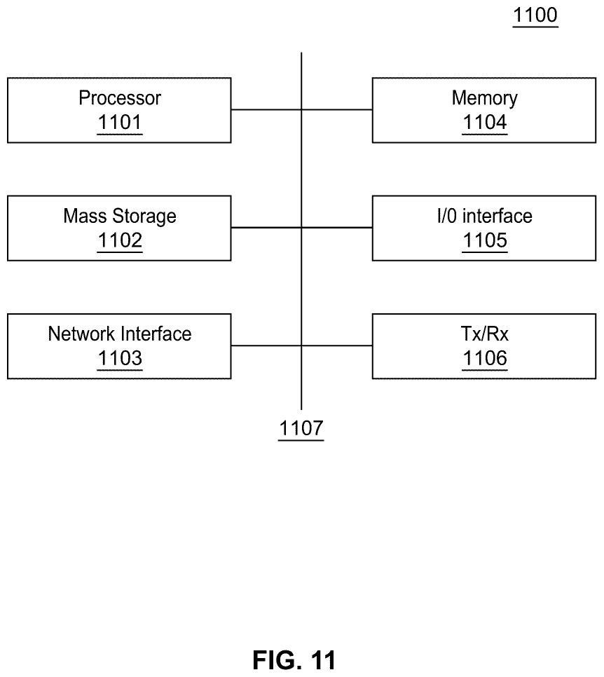

FIG. 11 illustrates a schematic diagram of an electronic device 1100 that may perform any or all of operations of the above methods and features explicitly or implicitly described herein, according to different embodiments of the present disclosure. For example, a computer equipped with network function may be configured as an electronic device 1100. Such an electronic device may be used as part of one or more of: a controller, an edge server, a processing device, a bounding region module, an AV, an RSU, etc. Multiple such devices networked together may be used to perform operations as described herein. Networked computing devices can host various functions as described herein, and may employ network function virtualization or similar technology to facilitate such hosting. Other network infrastructure devices, such as base stations, eNBs, gNBs, components of distributed base stations, eNBs or gNBs, access points, or the like, may also be employed. More generally, an apparatus employing networking and computing functions may be configured to operate one of more of the functions as described herein (e.g. DWSF, D2RAF, R2DAF, etc.). Sensors and actuators can be operated by such an apparatus.

As shown, the device includes a processor 1101, such as a Central Processing Unit (CPU) or specialized processors such as a Graphics Processing Unit (GPU) or other such processor unit, memory 1104, non-transitory mass storage 1102, I/O interface 1105, network interface 1103, and a transceiver 1106, all of which are communicatively coupled via bi-directional bus 1107. According to certain embodiments, any or all of the depicted elements may be utilized, or only a subset of the elements. Further, the device 1100 may contain multiple instances of certain elements, such as multiple processors, memories, or transceivers. Also, elements of the hardware device may be directly coupled to other elements without the bi-directional bus. Additionally or alternatively to a processor and a memory, other processing electronics, such as application specific integrated circuits, field programmable gate arrays, digital circuitry, analog circuitry, or the like, or a combination thereof may be employed for performing the required logical operations. Each integrated circuit may include one or more of semiconductor chips, and semiconductor chiplets.

The memory 1104 may include any type of non-transitory memory such as static random access memory (SRAM), dynamic random access memory (DRAM), synchronous DRAM (SDRAM), read-only memory (ROM), any combination of such, or the like. The mass storage element 1102 may include any type of non-transitory storage device, such as a solid state drive, hard disk drive, a magnetic disk drive, an optical disk drive, USB drive, or any computer program product configured to store data and machine executable program code. According to certain embodiments, the memory 1104 or mass storage 1102 may have recorded thereon statements and instructions executable by the processor 1101 for performing any of the aforementioned method operations described above.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk, read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

1. A method for dynamic culling of gaussians to render a scene, the method comprising, by a device:
receiving a first plurality of gaussians representing the scene, each gaussian of the first plurality being associated with a respective first parameter and a respective second parameter;
receiving a first threshold value and a second threshold value;
receiving a request to render the scene;
initiating a discovery operation to discover at least one gaussian of the first plurality, a value of a first parameter of the at least one gaussian is less than the first threshold value and a value of a second parameter of the at least one gaussian is less than the second threshold value;
in response to determining that the discovery operation to discover the at least one gaussian was successful, culling the at least one gaussian;
generating a second plurality of gaussians, the second plurality of gaussians being based at least in part on the first plurality of gaussians, each gaussian of the second plurality of gaussians being associated with a respective first parameter and a respective second parameter, and a value of the respective first parameter is equal to or greater than the first threshold value, or a value of the respective second parameter is equal to or greater than the second threshold value, or both; and generating a rendered image of the scene using the second plurality of gaussians.

2. The method of claim 1,
wherein the each gaussian of the second plurality of gaussians associated with a respective plurality of attributes;
wherein the respective first parameter being based at least in part on one or more attributes of the respective plurality of attributes; and
wherein the respective second parameter being based at least in part on at least one attribute of the respective plurality of attributes.

3. The method of claim 2,
wherein the respective plurality of attributes includes a corresponding opacity attribute; and
the respective first parameter is a respective opacity parameter, and the value of the respective first parameter is a value of the corresponding opacity attribute.

4. The method of claim 2,
wherein the respective plurality of attributes includes corresponding one or more rotation attributes, corresponding one or more scale attributes, or a combination thereof; and
the respective second parameter is a respective granularity parameter, and the value of the respective second parameter is based at least in part on values of the corresponding one or more scale attributes, on values of the corresponding one or more rotation attributes, or a combination of thereof.

5. The method of claim 2, wherein the respective second parameter is a respective granularity parameter, and the value of the respective second parameter is based at least in part on a distance from the each gaussian of the second plurality to a camera viewpoint.

6. A method for dynamic culling of gaussians to render a scene, the method comprising, by a device:
receiving a first plurality of gaussians representing the scene, each gaussian of the first plurality being associated with a respective first parameter and a respective second parameter;
receiving a first threshold value and a second threshold value;
receiving a third threshold value and a fourth threshold value;
receiving a request to render the scene;
initiating a discovery operation to discover at least one gaussian of the first plurality, a value of a first parameter of the at least one gaussian is less than the first threshold value and a value of a second parameter of the at least one gaussian is less than the second threshold value;
in response to determining that the discovery operation to discover the at least one gaussian was successful, culling the at least one gaussian;
generating a second plurality of gaussians, the second plurality of gaussians being based at least in part on the first plurality of gaussians, each gaussian of the second plurality of gaussians being associated with a respective first parameter and a respective second parameter, and a value of the respective first parameter is equal to or greater than the first threshold value, or a value of the respective second parameter is equal to or greater than the second threshold value, or both;
generating a third plurality of gaussians, the third plurality of gaussians being based at least in part on the second plurality of gaussians, each gaussian of the third plurality of gaussians being associated with a respective first parameter and a respective second parameter, and a value of the respective first parameter is equal to or greater than the third threshold value, or a value of the respective second parameter is equal to or greater than the fourth threshold value, or both;
generating a fourth plurality of gaussians, the fourth plurality of gaussians being based at least in part on the second plurality of gaussians, each gaussian of the fourth plurality of gaussians being associated with a respective first parameter and a respective second parameter, a value of the respective first parameter is less than the third threshold value and a value of the respective second parameter is less than the fourth threshold value; and
generating a rendered image of the scene using the third and the fourth plurality of gaussians.

7. The method of claim 6,
wherein the each gaussian of the second plurality of gaussians, the each gaussian of the third plurality, the each gaussian of the fourth plurality is associated with a respective plurality of attributes; and
wherein each attribute has a respective scalar quantization.

8. The method of claim 7, further comprising:
prior to said generating the rendered image of the scene, selecting one or more attributes from the respective plurality of attributes of the each gaussian of the fourth plurality; and
adjusting a corresponding scalar quantization of the one or more attributes from the respective plurality of attributes of the each gaussian of the fourth plurality.

9. The method of claim 8, wherein said adjusting the corresponding scalar quantization is replacing a 32-bit representation with a reduced value representation.

10. The method of claim 8, wherein the one or more attributes are spherical harmonic attributes.

11. The method of claim 7,
wherein the respective first parameter of the each gaussian of the second plurality being based at least in part on one or more attributes of the respective plurality of attributes;
wherein the respective first parameter of the each gaussian of the third plurality being based at least in part on one or more attributes of the respective plurality of attributes;
wherein the respective first parameter of the each gaussian of the fourth plurality being based at least in part on one or more attributes of the respective plurality of attributes; and
wherein the respective second parameter of the each gaussian of the second plurality being based at least in part on at least one attribute of the respective plurality of attributes;
wherein the respective second parameter of the each gaussian of the third plurality being based at least in part on at least one attribute of the respective plurality of attributes; and
wherein the respective second parameter of the each gaussian of the fourth plurality being based at least in part on at least one attribute of the respective plurality of attributes.

12. The method of claim 7,
wherein the respective plurality of attributes of the each gaussian of the second plurality, the respective plurality of attributes of the each gaussian of the third plurality, and the respective plurality of attributes of the each gaussian of the fourth plurality includes a corresponding opacity attribute;
the respective first parameter of the each gaussian of the second plurality is a respective opacity parameter of the each gaussian of the second plurality, and the value of the respective first parameter of the each gaussian of the second plurality is a value of the corresponding opacity attribute;
the respective first parameter of the each gaussian of the third plurality is a respective opacity parameter of the each gaussian of the third plurality, and the value of the respective first parameter of the each gaussian of the third plurality is a value of the corresponding opacity attribute; and
the respective first parameter of the each gaussian of the fourth plurality is a respective opacity parameter of the each gaussian of the fourth plurality, and the value of the respective first parameter of the each gaussian of the fourth plurality is a value of the corresponding opacity attribute.

13. The method of claim 7,
wherein the respective plurality of attributes of the each gaussian of the second plurality includes corresponding one or more rotation attributes, corresponding one or more scale attributes, or a combination thereof; and
the respective second parameter of the each gaussian of the second plurality is a respective granularity parameter, and the value of the respective second parameter of the each gaussian of the second plurality is based at least in part on values of the corresponding one or more scale attributes, on values of the corresponding one or more rotation attributes, or a combination of thereof.

14. The method of claim 7, wherein the respective second parameter of the each gaussian of the second plurality is a respective granularity parameter, and the value of the respective second parameter is based at least in part on a distance from the each gaussian of the second plurality to a camera viewpoint.

15. The method of claim 7,
wherein the respective plurality of attributes of the each gaussian of the third plurality includes corresponding one or more rotation attributes, corresponding one or more scale attributes, or a combination thereof; and
the respective second parameter of the each gaussian of the third plurality is a respective granularity parameter, and the value of the respective second parameter of the each gaussian of the third plurality is based at least in part on values of the corresponding one or more scale attributes, on values of the corresponding one or more rotation attributes, or a combination of thereof.

16. The method of claim 7, wherein the respective second parameter of the each gaussian of the third plurality is a respective granularity parameter, and the value of the respective second parameter is based at least in part on a distance from the each gaussian of the third plurality to a camera viewpoint.

17. The method of claim 7,
wherein the respective plurality of attributes of the each gaussian of the fourth plurality includes corresponding one or more rotation attributes, corresponding one or more scale attributes, or a combination thereof; and
the respective second parameter of the each gaussian of the fourth plurality is a respective granularity parameter, and the value of the respective second parameter of the each gaussian of the fourth plurality is based at least in part on values of the corresponding one or more scale attributes, on values of the corresponding one or more rotation attributes, or a combination of thereof.

18. The method of claim 7, wherein the respective second parameter of the each gaussian of the fourth plurality is a respective granularity parameter, and the value of the respective second parameter is based at least in part on a distance from the each gaussian of the fourth plurality to a camera viewpoint.

19. A device to support dynamic culling of gaussians to render a scene, the device includes one or more processors executing instructions stored on a memory, the device configured to:
receive a first plurality of gaussians representing the scene, each gaussian of the first plurality being associated with a respective first parameter and a respective second parameter;
receive a first threshold value and a second threshold value;
receive a request to render the scene;
initiate a discovery operation to discover at least one gaussian of the first plurality, a value of a first parameter of the at least one gaussian is less than the first threshold value and a value of a second parameter of the at least one gaussian is less than the second threshold value;
in response to determining that the discovery operation to discover the at least one gaussian was successful, cull the at least one gaussian;
generate a second plurality of gaussians, the second plurality of gaussians being based at least in part on the first plurality of gaussians, each gaussian of the second plurality of gaussians being associated with a respective first parameter and a respective second parameter, and a value of the respective first parameter is equal to or greater than the first threshold value, or a value of the respective second parameter is equal to or greater than the second threshold value, or both; and
generate a first rendered image of the scene using the second plurality of gaussians.

20. The device of claim 19 further configured to:
prior said receipt of the request to render the scene, receive a third threshold value and a fourth threshold value;
following said generation of the second plurality of gaussians, generate a third plurality of gaussians, the third plurality of gaussians being based at least in part on the second plurality of gaussians, each gaussian of the third plurality of gaussians being associated with a respective first parameter and a respective second parameter, and a value of the respective first parameter is equal to or greater than the third threshold value, or a value of the respective second parameter is equal to or greater than the fourth threshold value, or both;
generate a fourth plurality of gaussians, the fourth plurality of gaussians being based at least in part on the second plurality of gaussians, each gaussian of the fourth plurality of gaussians being associated with a respective first parameter and a respective second parameter, a value of the respective first parameter is less than the third threshold value and a value of the respective second parameter is less than the fourth threshold value; and
generate a second rendered image of the scene using the third and the fourth plurality of gaussians.
